(19) United States
(12) Patent Application Publication
(10) Pub. No.: US 2026/0201745 A1
(43) Pub. Date: Jul. 16, 2026

(54) A DEVICE FOR RESIZING A WINDOW COVERING ARRANGEMENT

(71) Applicant: Inter IKEA Systems B.V., Delft (NL)

(72) Inventor: Bo Zhang, Lund (SE)

(21) Appl. No.: 19/134,697

(22) PCT Filed: Dec. 1, 2023
(86) PCT No.: PCT/SE2023/051212

§ 371 Date: May 30, 2025

(30) Foreign Application Priority Data
Dec. 1, 2022 (SE) 2251401-2

(51) Int. Cl. E06B 9/266; B26B 29/06

(52) U.S. Cl. CPC E06B 9/266; B26B 29/06

(57) ABSTRACT

A device for resizing a window covering arrangement to fit within a window frame adjacent a window is disclosed. The device includes a retainer that comprises a rod receptacle for receiving a window covering support rod. The retainer includes a window covering cross bar receptacle for receiving a window covering cross bar, and/or a window covering receptacle for receiving a window covering in a compressed state. A first cutting guide is adapted to guide a first, second, and/or third cutting tool during cutting of the rod for shortening the rod, during cutting of the cross bar for shortening the cross bar, and/or during cutting of the window covering for shortening the window covering in a sideways direction.

### CROSS-REFERENCE TO RELATED APPLICATIONS

This application claims priority to International Patent Application No. PCT/SE2023/051212 filed Dec. 1, 2023, which also claims priority to Swedish Patent Application SE 2251401-2 filed Dec. 1, 2022, the contents of each of which is hereby incorporated by reference in its entirety.

### TECHNICAL FIELD

The invention relates to a device for resizing a window covering arrangement to fit within a window frame adjacent a window.

### BACKGROUND

Such a window covering arrangement is adapted for at least partially covering a window, wherein the arrangement comprises a window covering adapted for being arranged in different intermediate extension states between a retracted state and an extended state for covering the window to different extents. Further, the window covering may be arranged to substantially cover the complete window in the extended state. Preferably, the covering may be extendable in a continuous way for assuming any intermediate position between the retracted state and the extended state. The window may be arranged in a vertical wall, or be formed by a roof light, in a door etc in a building.

Window coverings are used to cover a window to, for example, manage sunlight, to provide insulation, blackout, to ensure privacy or security, to keep insects out or for purely decorative purposes. The window coverings are adapted for being arranged on the interior side of windows. Window coverings may also be referred to as window furnishings, blinds, screens or shades.

Further, window coverings may be of various designs, such as comprising a pleated structure of an open type or a cellular type (also called honeycomb blinds). Such pleated structures may be formed by a fabric. According to an alternative, the window covering may be formed by a so-called Venetian blind having numerous horizontal slats that may be set simultaneously at any of several angles. The slats may be of a rigid character, such as formed by a plastic material or wood-based material.

Further, the window covering arrangement may comprise at least one window covering cross bar that is adapted to extend in a transverse direction of the window covering and comprises an engagement portion for engagement with one of the opposite ends of the window covering in its extension direction so that the window covering may be moved to different extension states via movement of the window covering cross bar. The window covering cross bar may alternatively be termed a rail. According to one example, the arrangement comprises two window covering cross bars, which are arranged at each one of the opposite ends of the window covering in its extension direction. The two window covering cross bars may then be termed head rail and bottom rail or upper track and lower track. The window covering cross bar may be formed by a rigid body, which may be formed in a plastic or metallic material.

Variations in size and shape of windows create a challenge in providing window covering arrangements which properly fit such windows. Window covering arrangements are often produced in predefined certain dimensions adapted for matching windows of different sizes. A user may then have to resize the window covering arrangement to match his or her specific window. More specifically, the window covering may be produced in a standard initial width and is formed in a material which can be readily cut to exhibit an appropriate width.

Devices for resizing window covering arrangements are known. For example, U.S. Pat. No. 7,194,811B2 discloses a retainer for holding and guiding a cutting tool during cutting of a window covering for proper resizing in width. Further, US20070089583A1 discloses a retainer that comprises a first holding portion adapted for holding an upper track and a lower holding portion for holding a lower track on opposite sides of the window covering, wherein the retainer is adapted for holding and guiding a cutting tool during cutting of the upper track, the window covering and the lower track in a single cutting operation for proper resizing in width.

### SUMMARY

An object of the invention is to achieve a device for resizing a window covering arrangement, which device is versatile, compact and easy to use.

Future window covering arrangements may comprise a set of window covering support rods, normally two rods instead of cords for an improved child safety in that it reduces the risk of strangulation. Such a rod may be adapted to be attached to the window frame at either end so that it extends across the window frame and extending in parallel with the extension direction of the window covering. The window covering and/or the window covering cross bars is in turn formed with a set of inline apertures for receipt of the rod so that the window covering may be supported by the rod and movably arranged in a longitudinal direction of the rod between the different extension states in the extension direction. Such a window covering support rod is rigid, ie substantially non-bendable, and may be formed in a metallic material.

The object is achieved by a device according to claim 1. Thus, it is achieved by a device for resizing a window covering arrangement to fit within a window frame adjacent a window, wherein the device comprises a retainer that comprises a rod receptacle for receiving a window covering support rod and a first cutting guide adapted to guide a first cutting tool during cutting of the rod for shortening the rod. Thus, the device is adapted for aiding an end user in shortening an initial length of a window covering support rod to a desired length in order to properly fit a specific window.

The retainer may comprise a window covering cross bar receptacle for receiving a window covering cross bar, and/or a window covering receptacle for receiving a window covering in a compressed state. The first cutting guide may further be adapted to, alone or in combination with one or more additional cutting guides, guide a second, and/or third cutting tool during cutting of the cross bar for shortening the cross bar, and/or during cutting of the window covering for shortening the window covering in a sideways direction.

According to one example, the window covering arrangement comprises a window covering adapted for being arranged in different intermediate extension states between a retracted state and an extended state for covering the window to different extents and at least one such window covering support rod adapted to be attached to the window frame and adapted to support the window covering. Preferably, the window covering is extendable in a continuous way for assuming any intermediate position between the retracted state and the extended state. Further, the window covering may be adapted for a manual movement to a desired extension state and position with regard to the window. Further, the window covering may be extendable in parallel with a plane. The window covering may be designed so that the boundaries of the window covering define a rectangular shape in the extended state. Preferably, the window covering comprises at least one set of apertures, which are arranged in-line with each other in the extension direction of the window covering, for receipt of the rod

According to one example, the window covering arrangement comprises at least two such rods, which are adapted to be arranged in a spaced relationship in a direction perpendicular to the extension direction of the window covering.

According to a further example, the rod has the same cross section shape and dimension along substantially its complete length. According to one example, the rod has a circular shape in cross section. The rod may have a somewhat smaller cross section in relation to the cross section of the aperture so that the window covering may run substantially freely (without friction) along the rod.

According to one example, the first cutting tool may comprise a handle and an elongated cutting blade connected to the handle. Further, the cutting blade may have a toothed structure. According to one example, the first cutting tool is formed by a saw.

According to one embodiment example, the rod receptacle comprises two rod contact surfaces spaced from each other and in an angled relationship forming a tapering shape for supporting the rod during the cutting of the rod. Such a design creates conditions for an easy placement of the rod in an intended position in the rod receptacle and good support of the rod in a sideways direction during the cutting of the rod.

According to one further embodiment example, the rod receptacle defines an elongated recess adapted for receiving the rod in a way that a longitudinal direction of the rod is in parallel with a longitudinal direction of the elongated recess. Such an elongated recess creates conditions for the rod receptacle to be in contact with the rod along a portion of the rod length, which creates further conditions for a good support of the rod in a sideways direction during the cutting of the rod and facilitates a cut surface perpendicular to the longitudinal direction of the rod. According to one example, the elongated recess has a length in its longitudinal direction of at least 2 cm especially at least 3 cm and preferably at least 4 cm.

According to one example, the first cutting guide extends in a transverse direction relative to a longitudinal direction of the elongated rod receptacle recess. According to one example, the first cutting guide extends perpendicularly relative to a longitudinal direction of the elongated rod receptacle recess.

According to one further embodiment example, the first cutting guide comprises at least one cutting slot. A cutting slot creates further conditions for a good support of the first cutting tool since the portions defining the cutting slot provides support for the first cutting tool from opposite sides. The dimension of the slot may be designed for matching the corresponding dimension of a cutting blade of the cutting tool. According to one example, the first cutting guide has a linear extension.

According to one further embodiment example, the retainer comprises two lateral walls arranged in a spaced relationship, wherein the rod receptacle for receiving the rod is located between the lateral walls and wherein the first cutting guide is formed in at least one of the lateral walls. Such a retainer design creates conditions for an easy cutting operation. According to one example, each one of the two lateral walls is substantially planar. According to a further example, the two lateral walls are arranged in parallel with each other. The two lateral walls may have the same size and shape.

According to one example, the elongated rod receptacle recess is arranged so that its longitudinal direction is in parallel with at least one of the two lateral walls.

According to one further embodiment example, the first cutting guide comprises a first cutting slot arranged in a first one of the lateral walls and a second cutting slot arranged in a second one of the lateral walls and wherein the first cutting slot and the second cutting slot are aligned for simultaneously receiving one single cutting tool. Such an in-line arrangement of the cutting slots creates conditions for a good support of the cutting tool, that may be a saw or a knife or similar, at two spaced portions of the cutting tool in its extension direction.

According to one further embodiment example, the retainer comprises a bottom wall, wherein the rod receptacle is arranged on a first side of the bottom wall and wherein the rod receptacle is open in a first direction perpendicular to a main extension plane of the bottom wall. Such a design creates conditions for an easy placement of the rod in the rod receptacle since the rod receptacle may be visible from above.

According to one example, each one of the cutting slots is open at a free end of the lateral walls opposite the bottom wall. Accordingly, the first cutting tool may be directed from the free end of the lateral walls towards the rod receptacle. According to one example, each one of the cutting slots has an end proximate to the bottom wall, wherein a straight line connecting the ends of the first and second cutting slot is below the rod receptacle.

According to one further embodiment example, the retainer comprises an elongated portion projecting from the bottom wall, wherein the rod receptacle is formed in the elongated portion so that the elongated rod receiving recess extends in parallel with the elongated portion.

According to one example, the elongated portion projecting from the bottom wall extends in parallel with the main extension plane of the bottom wall.

According to one further embodiment example, the two lateral walls extend upwards from the bottom wall, wherein the rod receptacle is arranged between the two lateral walls. According to one example, the rod receptacle is arranged in parallel with the lateral walls and centrally between the lateral walls. According to one example, the elongated portion projecting from the bottom wall extends in parallel with the two lateral walls.

According to one example, the retainer may have a design that is mirrored in a central plane between the lateral walls and perpendicular to the main extension plane of the bottom wall. Such a design creates conditions for the retainer to be used in any one of two orientations angled with 180° relative to one another.

According to one example, the two lateral walls have a longer extent perpendicular to the main extension plane of the bottom wall than the elongated portion projecting from the bottom wall. In this way, the cutting toll may be directed/guided properly by the first cutting guide before reaching the rod during cutting of the rod.

According to one further embodiment example, the bottom wall comprises a support surface arranged on a second side of the bottom wall, wherein the support surface faces in a second direction opposite the first direction for supporting the device against an external support during the cutting of the rod. According to one example, the bottom wall support surface may be adapted to support against a planar surface, such as an upper surface of a table. According to one example, the bottom wall support surface may be substantially planar. According to one example, the bottom wall support surface may be provided with an adhesive for adhesion with the external support surface. According to one example, the bottom wall support surface may be provided with a removable strip that exposes the adhesive when removed.

According to one further embodiment example, the retainer comprises a window covering cross bar receptacle for receiving the cross bar and a second cutting guide adapted to guide a second cutting tool during cutting of the cross bar for shortening the cross bar.

The window covering cross bar is adapted to extend in a transverse direction of the window covering and comprises an engagement portion for engagement with one of the opposite ends of the window covering in its extension direction so that the window covering may be moved to different extension states via movement of the window covering cross bar.

According to one example, the arrangement comprises two such window covering cross bars, which are arranged at each one of the opposite ends of the window covering in its extension direction. The two window covering cross bars may alternatively be termed head rail and bottom rail. The window covering cross bar may be formed by a rigid body, which may be formed in a plastic or metallic material. According to one example, the at least one window covering cross bars may comprise a handle portion for manual manoeuvring of the window covering between the different extension states.

Accordingly, the window covering cross bars may be produced to a single length adapted for windows of different widths, wherein an operator or end customer may cut the window covering cross bars to a desired width matching a width of the specific window to which the window covering is intended.

According to one further embodiment example, the cross bar receptacle is defined in a sideways direction by the two lateral walls and in a downwards direction by the bottom wall and more particularly by an upper surface of the elongated portion. It creates further conditions for a space-efficient device. According to one example, the upper surface of the elongated portion is substantially flat/planar and parallel with the main extension plane of the bottom wall.

According to one further embodiment example, the cross bar receptacle comprises an elongated recess that is open in the first direction for receiving a complimentary shaped portion of the cross bar for holding the cross bar in a fixed position during cutting and wherein the cross bar elongated recess is spaced from the rod receptacle. It creates further conditions for an easy cutting operation. According to one example, the cross bar comprises an elongated main body and an elongated thin curved section in one piece with the elongated main body and projecting from the elongated main body. The elongated recess of the cross bar receptacle may have a complimentary curved shape for receipt of the elongated thin curved section of the cross bar.

According to one further embodiment example, the second cutting guide is formed by the same structure as the first cutting guide. Using the same cutting guide for both cutting of the rod and cutting of the cross bar creates further conditions for an easy cutting operation. Further, the same cutting tool may be used for both cutting the rod and cutting the cross bar.

According to one further embodiment example, the retainer comprises a window covering receptacle for receiving the window covering in a compressed state and a third cutting guide adapted to guide a third cutting tool during cutting of the window covering for shortening the window covering in a sideways direction.

Accordingly, the window covering may be produced to a single size (height and width) adapted for windows of different widths, wherein an operator or end customer may cut the window covering to a desired width matching a width of the specific window to which the window covering is intended. According to one example, the window covering comprises a plurality of parallel and spaced sets of apertures, each set having apertures arranged in-line with each other in the extension direction of the window covering. In this way, an operator or end customer may select one of said set of in-line apertures for receipt of the rod after the cutting of the window covering.

According to one further embodiment example, the window covering receptacle is defined in a sideways direction by the two lateral walls and in a downwards direction by the bottom wall and more particularly by the upper surface of the elongated portion. It creates conditions for a space-efficient device.

According to one further embodiment example, the third cutting guide is formed by the same structure as the first cutting guide. Using the same cutting guide for both cutting of the window covering and cutting of the rod (and cutting of the cross bar) creates further conditions for an easy cutting operation. The cutting tool for cutting the window covering may be different from the cutting tool for cutting the rod and the cross bars. More specifically, the cutting tool for cutting the window covering may be formed by a knife or similar tool having a sharp cutting edge.

According to one further embodiment example, the device comprises a window covering fixing piece that is adapted to fix the window covering in the compressed state during cutting, wherein the retainer and the fixing piece comprises complimentary shaped guide means for guiding the fixing piece in a direction towards the bottom wall for acting on the window covering. It creates conditions for an easy cutting operation of the window covering in that the window covering fixing piece provides a support for an operator or end user in fixing the window covering during the cutting operation.

According to one further embodiment example, the holding piece guide means in the retainer is arranged spaced from the first cutting guide. By proper design of the holding piece and a distance between the holding piece guide means and the first cutting guide, it creates conditions for an easy cutting operation. According to one example, the holding piece guide means in the retainer is formed by a slot. According to one example, the holding piece guide means slot has the same shape, size and length as the first cutting slot. According to one example, the holding piece guide means slot and the first cutting slot are arranged in parallel with each other. According to one example, the retainer may have a design that is mirrored in a central plane between the slots and perpendicular to the main extension plane of the bottom wall. Such a design creates conditions for the retainer to be used so that any one of the two slots is used for the cutting tool and the other one of the two slots is used for the guiding of the holding piece guide means. It creates further conditions for a facilitated use in that the operator may use either the right or left hand for operating the cutting tool. It creates further conditions for a facilitated use in that the retainer may be used in any one of two orientations angled with 180° relative to one another.

According to one further embodiment example, the window covering cross bar receptacle and the window covering receptacle are at least partly defined by the same space for cutting of one of the window covering cross bar and the window covering in a first cutting operation and cutting of a second one of the window covering cross bar and the window covering in a second cutting operation. In other words, only one of the window covering cross bar and the window covering fits in the space at a time. It creates further conditions for a space-efficient device.

One further object of the invention is to achieve a window covering arrangement, which creates conditions for an easy resizing to fit a specific window.

The object is achieved by a window covering arrangement according to claim 21. Thus, it is achieved by a window covering arrangement comprising a window covering adapted for being arranged in different intermediate extension states between a retracted state and an extended state for covering a window to different extents, wherein the window covering comprises a plurality of sets of apertures, wherein the apertures in each set are arranged in-line with each other in the extension direction of the window covering for receipt of a rod so that the window covering may be supported by the rod and movably arranged in a longitudinal direction of the rod between the different extension states in the extension direction, wherein the sets of apertures are spaced from each other in a direction perpendicular to the window covering extension direction, wherein the window covering is provided with a plurality of graduations, wherein each graduation is associated to one of the sets of apertures, wherein indica is placed adjacent each graduation, wherein the indicia represent different intervals of a width of a window frame, in which the window covering is to be placed so that a user gets guidance in selecting one of the graduations for cutting the window covering for properly resizing the window covering.

According to one example, the window covering arrangement comprises two rods, wherein a first one of the rods is arranged in a selected set of in-line apertures adjacent a right edge of the window covering and a second one of the rods is arranged in a selected set of in-line apertures adjacent a left edge of the window covering.

According to one further example, the graduations and indicia can be attached, engraved, embossed, printed or otherwise formed into the window covering, such as to the top of the window covering, in a permanent or removable fashion.

According to one further example, the window covering is adapted so that it does not have a pattern or design indicating any centre line between the edges in its transverse direction. Accordingly, it is sufficient to cut the window covering at one of its edges. Accordingly, it is sufficient to provide the graduations and indicia adjacent one edge only of the window covering. According to one such example, the window covering is provided with the plurality of sets of apertures across its complete transverse extension.

According to one alternative, the window covering is adapted so that it has a pattern or design indicating a centre line between the edges in its transverse direction. In this case, a symmetrical amount should be cut from both the left edge and the right edge of the window covering to maintain a symmetrical appearance of the window covering. Accordingly, the graduations and indicia should be provided both adjacent the left edge of the window shade and adjacent the right edge of the window shade. According to one such example, the window covering is provided with a first group of sets of apertures adjacent a left edge of the window covering and a second group of sets of apertures adjacent a right edge of the window covering.

According to one further example, appropriate clearance at edges of the window covering is automatically accounted for by the indicia.

According to one embodiment example, the sets of apertures are arranged with equal spacing from each other in the direction perpendicular to the window covering extension direction. It creates conditions for a symmetrical appearance of the window covering after resizing to any width according to the graduations.

According to one example, each one of the graduations is spaced at an equal distance from its associated set of apertures. Accordingly, the edge of the window covering is at a set distance from the adjacent set of in-line apertures irrespective of which graduation is selected for cutting. It creates conditions for an attractive appearance irrespective of the width of the specific window. Accordingly, the rod may be located at the same distance from the window frame irrespective of the width of the window frame.

According to one further embodiment example, the sets of apertures are arranged at different distances away from an edge of the window covering. According to one example, a first set of apertures is located in close vicinity of the edge of the window covering.

According to one further embodiment example, the graduations are formed by linear parallel lines.

According to one further embodiment example, each indicium comprises a number and/or letter representative of one of the width intervals of the window frame.

According to one further embodiment example, the graduations and indicia are applied to an outermost portion of the window covering facing outwards in the extension direction.

According to one further embodiment example, the window covering arrangement comprises a look-up table that comprises a plurality of width intervals of the window frame and indicia associated to each one of the plurality of width intervals of the window frame. Thus, an end user may first measure a width of his or her window frame, then go into the look-up table to find an interval covering the measured width and then select an indicium associated to the found interval. In a next step, the end user may cut the window covering at the graduation associated to the selected indicium marked on the window covering.

According to one further embodiment example, the window covering arrangement comprises at least one window covering cross bar that is adapted to extend in a transverse direction of the window covering and comprises an engagement portion for engagement with one of the opposite ends of the window covering in its extension direction so that the window covering may be moved to different extension states via movement of the window covering cross bar, wherein the window covering cross bar is provided with graduations and indicia corresponding to the graduations and indicia provided on the window covering for properly resizing the window covering cross bar.

According to one further example, the graduations and indicia can be attached, engraved, embossed, printed or otherwise formed into the window covering cross bar, such as to the top of the window covering cross bar, in a permanent or removable fashion.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the Drawings:

FIG. 1 is a perspective view of parts of a room comprising a window and a window frame adjacent the window,

FIG. 2 is a perspective view of a window covering arrangement according to a first embodiment,

FIG. 3 is a perspective view of a device for resizing the window covering arrangement according to FIG. 2 to fit within the window frame according to FIG. 1, wherein the resizing device is formed in two parts,

FIG. 4 is a perspective view from below of the resizing device according to FIG. 3, wherein the two parts are in a connected state,

FIG. 5 is a perspective view from above of the resizing device according to FIG. 4 in an operative position on a table,

FIG. 6 is a perspective view from above of the resizing device according to FIG. 4 and a window covering support rod,

FIG. 7 is a perspective view from above of the resizing device and the window covering support rod according to FIG. 6 in an operative position for cutting,

FIG. 8 is a perspective view from above of package comprising a window covering and two cross bars connected to the ends of the window covering,

FIG. 9 is a perspective view from above of the window covering, wherein the two cross bars are disconnected from the ends of the window covering,

FIG. 10 is a perspective view from above of the resizing device according to FIG. 4 and one of the window covering cross bars in FIG. 9,

FIG. 11 is a perspective view from above of the resizing device and the window covering cross bar according to FIG. 10 in an operative position for cutting,

FIG. 12 is a perspective view from above of the resizing device according to FIG. 4 and a window covering in compressed state,

FIG. 13 is a perspective view from above of the resizing device and the window covering according to FIG. 12, wherein the resizing device comprises a window covering fixing piece,

FIG. 14 is a perspective view from above of the resizing device and the window covering according to FIGS. 12 and 13 in an operative position for cutting,

FIG. 15 is a perspective view of the resized window covering arrangement assembled in the window frame according to FIG. 1, and

FIG. 16 is a look-up table for guiding a user in resizing a window covering and a window covering cross bar.

### DETAILED DESCRIPTION

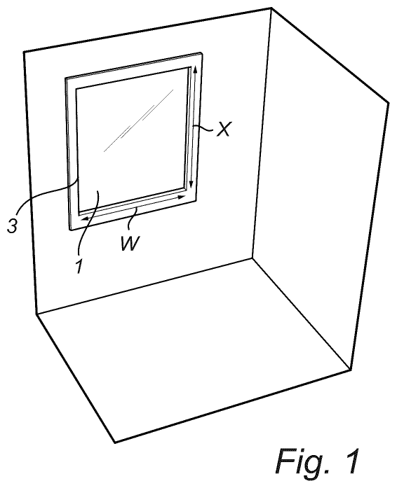

FIG. 1 is a perspective view of parts of a room comprising a window 1 and a window frame 3 adjacent the window. The window frame 3 has an internal height X and an internal width W.

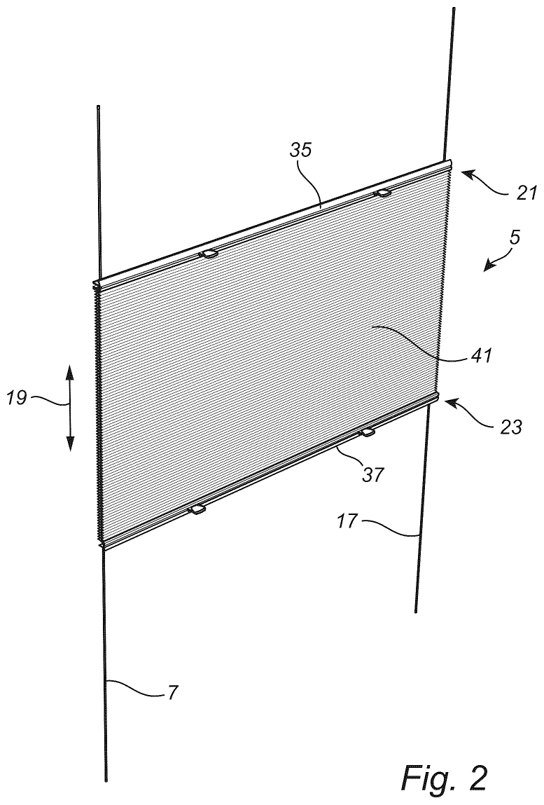

FIG. 2 is a perspective view of a window covering arrangement 5. The window covering arrangement 5 comprises a window covering 41 that is formed by a sheet element having a pleated structure. The window covering 41 is formed in a fabric. More specifically, the window covering 41 is formed by a woven fabric material. The window covering 41 is adapted for being arranged in different intermediate extension states between a retracted state and an extended state for covering the window 1 to different extents.

The window covering arrangement 5 further comprises two spaced window covering support rods 7, 17. Each one of the two spaced window covering support rods 7, 17 is straight. Further, the two spaced window covering support rods 7, 17 are arranged in parallel with each other and in parallel with an extension direction 19 of the window covering 41. Each one of the two spaced window covering support rods 7, 17 is arranged in the vicinity of an end of the window covering 41 in a transverse direction of the window covering. The window covering 41 is supported by the window covering support rods 7, 17 and movably arranged in a longitudinal direction of the window covering support rods 7, 17 between the different extension states in the extension direction 19. More specifically, the window covering 41 comprises a set of inline apertures at either end for receipt of the window covering support rods 7, 17.

Opposite ends 21, 23 of the window covering 41 define an upper boundary and a lower boundary of the window covering 41. The upper boundary is non-fixed and slidable in the longitudinal direction of the window covering support rods 7, 17. Likewise, the lower boundary is non-fixed and slidable in the longitudinal direction of the window covering support rods 7, 17. The shading range can thereby be adjusted by adjusting the height of the upper boundary and/or the lower boundary of the window covering. Thus, the window covering 41 may be said to be freely movable in the extension direction, which allows the user to freely position the shade along the window to achieve a desired shading.

Further, the window covering arrangement 5 comprises two window covering cross bars 35, 37 that are adapted to extend in a transverse direction of the window covering 41 and comprises an engagement portion for a rigid engagement with one of the opposite ends of the window covering in its extension direction so that the window covering 41 may be moved to different extension states via movement of the window covering cross bars 35, 37. The window covering cross bar 35, 37 may alternatively be termed rails. More specifically, the window covering arrangement 5 comprises two window covering cross bars 35, 37, which are arranged at each one of the opposite ends of the window covering 41 in its extension direction. The two window covering cross bars 35, 37 may then be termed head rail and bottom rail or upper track and lower track. The window covering cross bar 35, 37 is formed by a rigid body and more specifically in a plastic material. Each one of the window covering cross bars 35, 37 comprises an aperture at either end for receipt of the window covering support rods 7, 17. Further, each one of the window covering cross bars 35, 37 is adapted for securing the window covering cross bars 35, 37 in any position along the window covering support rods 7, 17.

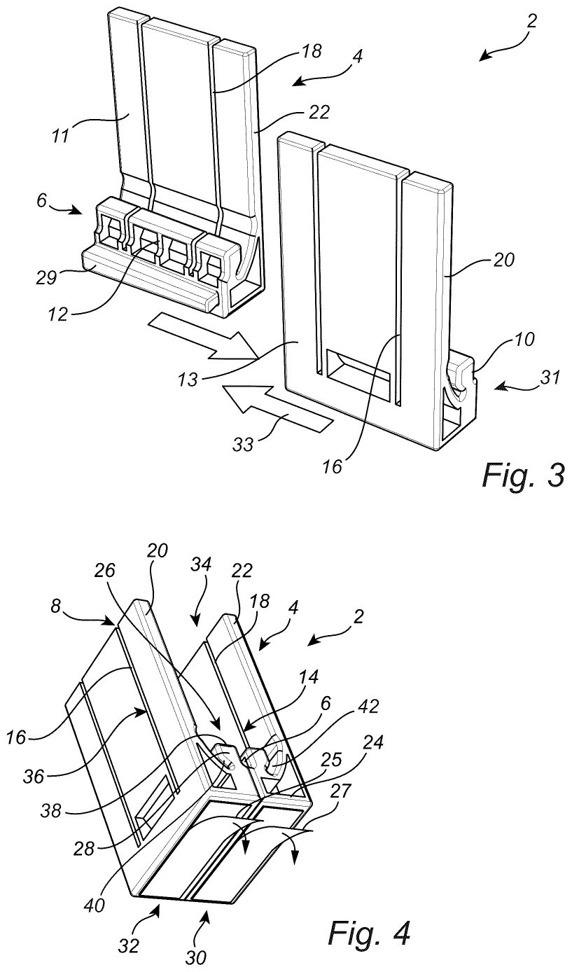

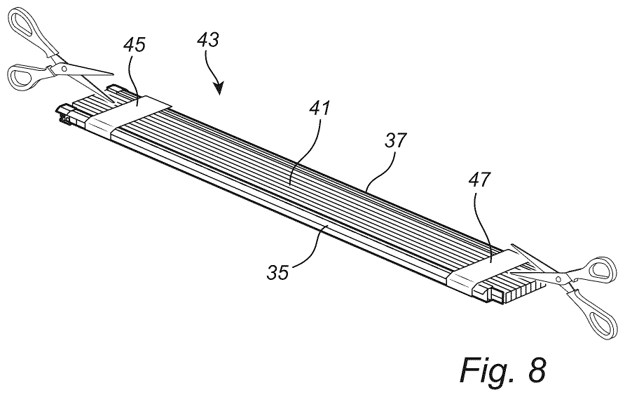

FIG. 3 is a perspective view of a device 2 for resizing the window covering arrangement 5 according to FIG. 2 to fit within the window frame 3 according to FIG. 1. The resizing device 2 comprises a retainer 4 that comprises a rod receptacle 6 for receiving the window covering support rod 7 and a first cutting guide 8, see FIG. 4, adapted to guide a first cutting tool 9, see FIG. 7, during cutting of the rod 7 for shortening the rod. The retainer 4 comprises two parts 11, 13 that are joined together to form a single unit. A first one of the parts 11 comprises a male section 29 and a second one of the parts 13 comprises a female section 31 (not shown), wherein the male section 29 and the female section 31 are adapted for engagement. More specifically, each one of the male section 29 and the female section 31 has an elongated shape. The two parts 11, 13 are adapted for being connected via a relative linear movement, see arrow 33, in an extension direction of the elongated male section 29. Further, the rod receptacle 6 comprises two rod contact surfaces 10, 12, wherein the first part 11 comprises a first rod contact surface 10 and the second part 13 comprises a second rod contact surface 12.

FIG. 4 is a perspective view from below of the resizing device 2 according to FIG. 3, wherein the two parts 11, 13 are in a connected state. The two rod contact surfaces 10, 12 are spaced from each other and arranged in an angled relationship forming a tapering shape for supporting the rod 7 during the cutting of the rod. The rod receptacle 6 defines an elongated recess 14 adapted for receiving the rod 7 in a way that a longitudinal direction of the rod is in parallel with a longitudinal direction of the elongated recess.

The first cutting guide 8 comprises at least one cutting slot 16, 18. Further, the retainer 4 comprises two lateral walls 20, 22 arranged in a spaced relationship, wherein the rod receptacle 6 for receiving the rod 7 is located between the lateral walls 20, 22 and wherein the first cutting guide 8 is formed in at least one of the lateral walls 20, 22. More specifically, the first cutting guide 8 comprises a first cutting slot 16 arranged in a first one of the lateral walls 20 and a second cutting slot 18 arranged in a second one of the lateral walls 22 and wherein the first cutting slot 16 and the second cutting slot 18 are aligned for simultaneously receiving one single cutting tool. The two lateral walls 20, 22 are planar and arranged in parallel with each other. Each one of the lateral walls 20, 22 has a rectangular shape. Further, the lateral walls 20, 22 are of the same size.

Further, each one of the two rod contact surfaces 10, 12 comprises a slot that is in line with the first cutting slot 16 and the second cutting slot 18, wherein the slot in the rod contact surfaces 10, 12 has an extension to a bottom of the rod contact surfaces 10, 12.

Further, the retainer 4 comprises a bottom wall 24, wherein the rod receptacle 6 is arranged on a first side 26 of the bottom wall 24 and wherein the rod receptacle is open in a first direction perpendicular to a main extension plane of the bottom wall 24. The retainer 4 comprises an elongated portion 28 projecting from the bottom wall 24, wherein the rod receptacle 6 is formed in the elongated portion 28 so that the elongated rod receiving recess 14 extends in parallel with the elongated portion 28. The elongated portion 28 extends in parallel with an extension plane of the bottom wall 24. The two lateral walls 20, 22 extend upwards from the bottom wall 24, wherein the rod receptacle 6 is arranged between the two lateral walls. Accordingly, the slots in the two rod contact surfaces 10, 12 extend throughout the elongated portion 28.

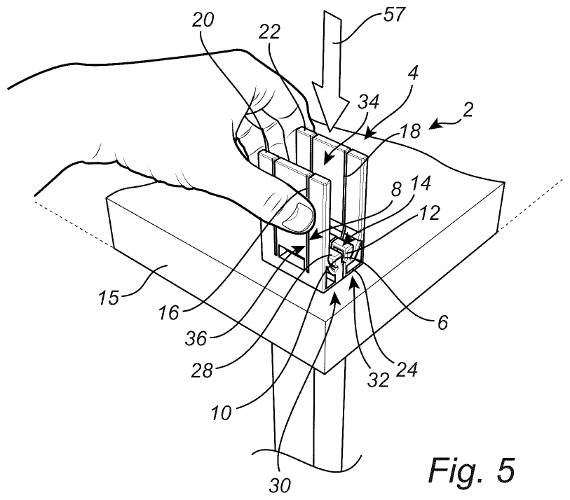

Further, the bottom wall 24 comprises a support surface 30 arranged on a second side 32 of the bottom wall 24, wherein the support surface faces in a second direction opposite the first direction for supporting the device against an external support 15, see FIG. 5, during the cutting of the rod. More specifically, the bottom wall support surface 30 is provided with an adhesive for adhesion with the external support 15. More specifically, the bottom wall support surface 30 is provided with two removable strips 25, 27, one on each one of the two parts 11, 13, that exposes the adhesive when removed.

FIG. 5 is a perspective view from above of the resizing device 2 according to FIG. 4 in an operative position on the external support 15 in the form of a table. An arrow 57 indicates a movement direction for manually placing the resizing device 2 on the table 15.

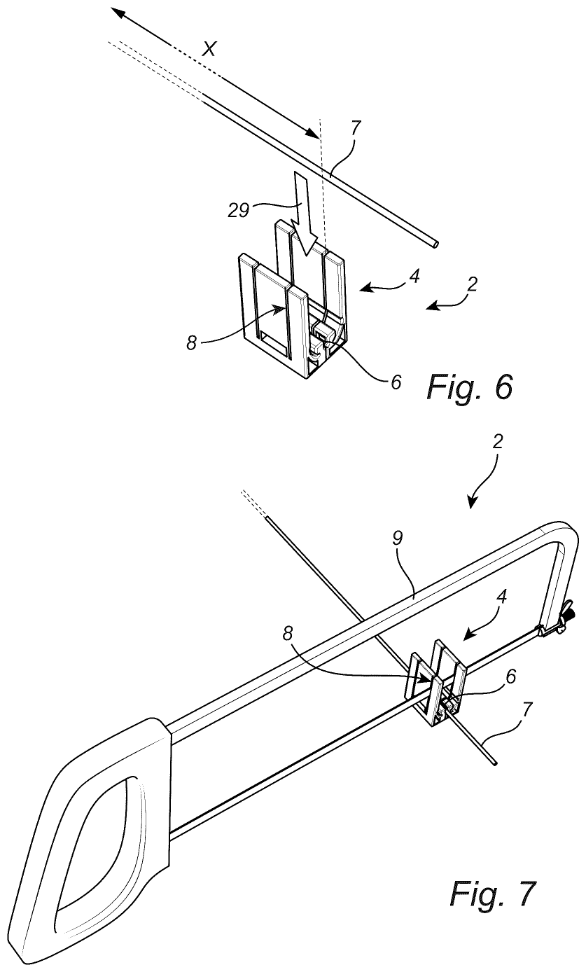

FIG. 6 is a perspective view from above of the resizing device 2 according to FIG. 4 and the window covering support rod 7, that is moved towards its operative position in the retainer 4, see arrow 29. FIG. 7 is a perspective view from above of the resizing device 2 and the window covering support rod 7 according to FIG. 6 in an operative position for cutting. The cutting tool 9 is in the form of a saw. Further, a cutting blade of the saw 9 is introduced in the cutting guide 8 and directed downwards towards the window covering support rod 7.

FIG. 8 is a perspective view from above of package 43 comprising the window covering 41 in a nominal width and the two cross bars 35, 37 connected to the ends of the window covering 41 in nominal lengths. The package 43 comprises two strips of packaging material 45, 47 that are wound around the window covering 41 and the two cross bars 35, 37 for maintaining the window covering 41 in a compressed state during transport.

The cross bar 35, 37 has a profile, which is constant over its complete length. The cross bar 35, 37 is rigid and may be formed in a plastic material, such as via extrusion.

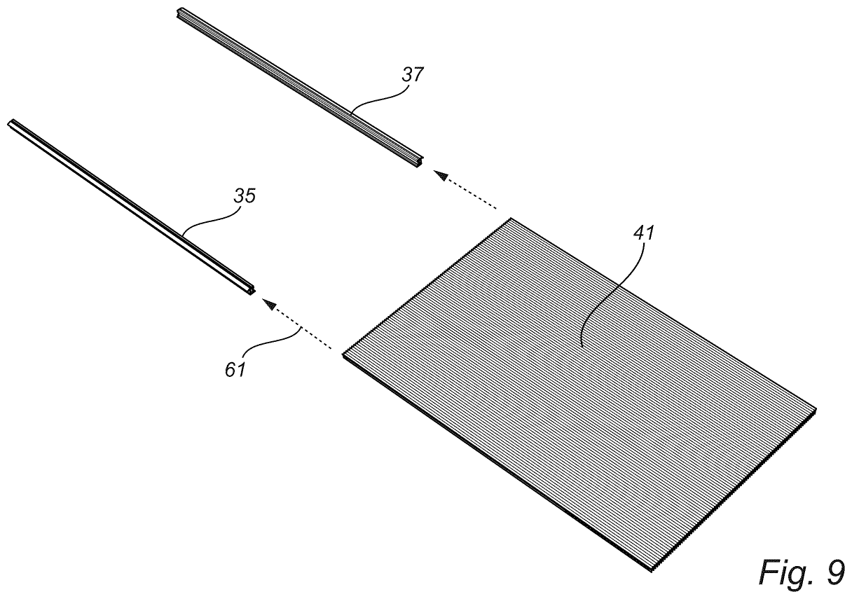

FIG. 9 is a perspective view from above of the window covering 41, wherein the two strips of packaging material 45, 47 have been removed. The two cross bars 35, 37 are disconnected from the ends of the window covering 41. More specifically, the ends of the window covering 41 is formed by a planar sheet-shaped section, which may be at least partly formed in plastics. The cross bar 35, 37 comprises a recess for receipt of the planar sheet-shaped section. Further, the recess and the planar sheet-shaped section may be formed by a dovetail structure. The cross bars 35, 37 may then be slid out from engagement with the window covering 41 in a sideways direction of the window covering in parallel with an extension direction of the cross bar 35, 37, see arrow 61.

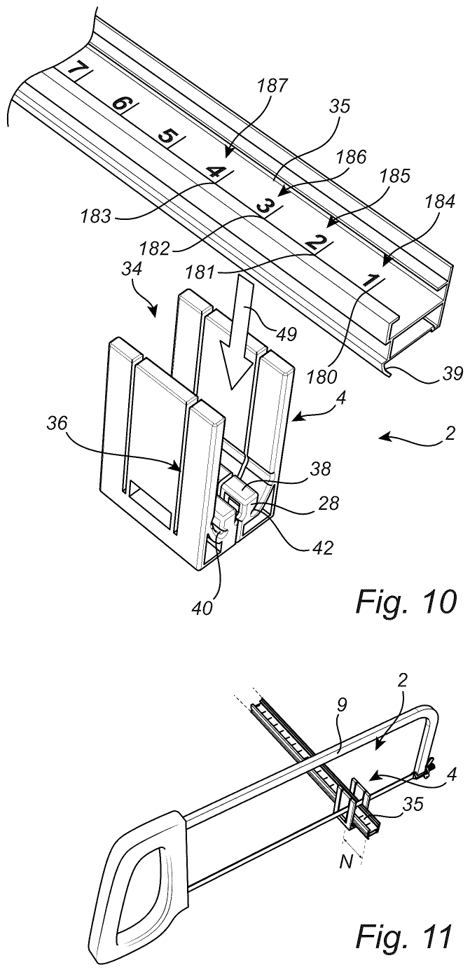

Turning now again to FIG. 4 and FIG. 5, the retainer 4 comprises a window covering cross bar receptacle 34 for receiving a window covering cross bar 35, 37 and a second cutting guide 36 adapted to guide a second cutting tool during cutting of the cross bar for shortening the cross bar. The cross bar receptacle 34 is defined in a sideways direction by the two lateral walls 20, 22 and in a downwards direction by an upper surface 38 of the elongated portion 28. More specifically, the cross bar receptacle 34 comprises an elongated recess 40, 42 that is open in the first direction for receiving a complimentary shaped portion 39 of the cross bar 35, see FIG. 10, for holding the cross bar in a fixed position during cutting and wherein the cross bar elongated recess 40,42 is spaced from the rod receptacle 6. It may be noted that the second cutting guide 36 is formed by the same structure as the first cutting guide 8.

FIG. 10 is a perspective view from above of the resizing device 2 according to FIG. 4 and one of the window covering cross bars 35, that is moved towards its operative position in the retainer 4, see arrow 49. FIG. 11 is a perspective view from above of the resizing device 2, the window covering cross bar 35 according to FIG. 10 in an operative position for cutting by means of the saw 9.

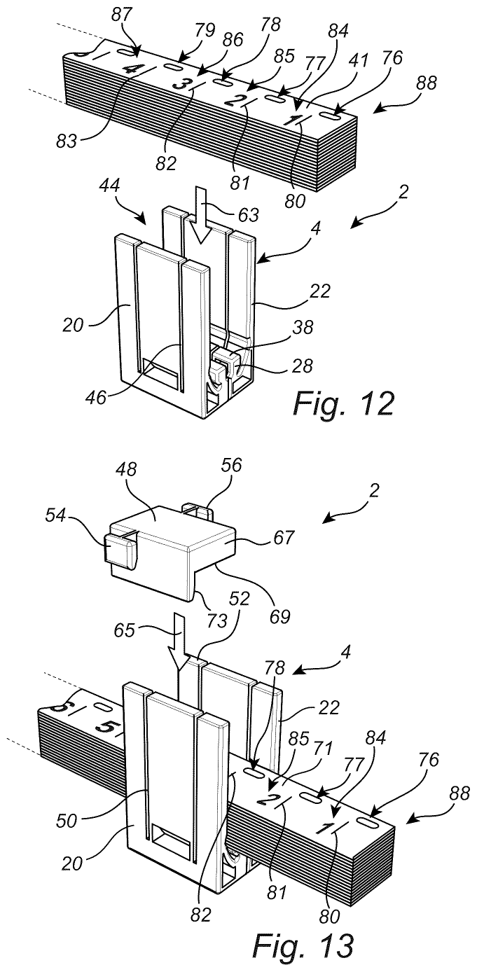

FIG. 12 is a perspective view from above of the resizing device 2 according to FIG. 4 and the window covering 41 in a compressed state. The retainer 4 comprises a window covering receptacle 44 for receiving the window covering 41 in the compressed state and a third cutting guide 46 adapted to guide a third cutting tool during cutting of the window covering for shortening the window covering 41 in a sideways direction. The window covering receptacle 44 is defined in a sideways direction by the two lateral walls 20, 22 and in a downwards direction by an upper surface 38 of the elongated portion 28. It may be noted that the third cutting guide 46 is formed by the same structure as the first cutting guide 8. The window covering 41 is moved between the lateral walls 20, 22 to its intended position for shortening, see arrow 63.

Further, the pleated structure of the window covering 41 comprises a plurality of sets 76, 77, 78, 79 of in-line apertures, wherein the apertures are arranged in-line with each other in the extension direction of the window covering 41. The plurality of sets 76, 77, 78, 79 of in-line apertures are arranged spaced from each other with equal distances in the transverse direction of the window covering 41. After cutting of the window covering 41 to resize it in its width direction, one of the sets 76, 77, 78, 79 of in-line apertures is used for receipt of the window covering support rod 35, 37.

FIG. 13 is a perspective view from above of the resizing device 2 and the window covering 41 according to FIG. 12, wherein the resizing device 2 comprises a window covering fixing piece 48 for use in association with the retainer 4. More specifically, the window covering fixing piece 48 is adapted to fix the window covering 41 in the compressed state during cutting, wherein the retainer 4 and the fixing piece 48 comprises complimentary shaped guide means 50, 52; 54, 56 for guiding the fixing piece in a direction towards the bottom wall 24 for acting on the window covering, see arrow 65. Further, the holding piece guide means 50, 52 in the retainer 4 is arranged spaced from the first cutting guide 8. More specifically, the holding piece guide means 50, 52 in the retainer 4 comprises a first guiding slot 50 arranged in a first one of the lateral walls 20 and a second guiding slot 52 arranged in a second one of the lateral walls 22 and wherein the first guiding slot 50 and the second guiding slot 52 are aligned.

The window covering fixing piece 48 comprises a main body 67. The guide means 54, 56 comprises projecting parts that project in opposite directions from the main body 67. Further, each one of the projecting parts 54, 56 comprises a relatively thin portion proximate to the main body 67 for being received in one of the guiding slots 50, 52 and an enlarged portion distant from the main body 67 for supporting on an outside surface of the lateral walls 20, 22. The main body 67 has a generally flat lower surface 69 that is adapted to contact an upper surface 71 of the window covering 41. The main body 67 is adapted to fit between the two lateral walls 20, 22. More specifically, the main body 67 comprises two lateral surfaces facing in opposite directions for contacting and/or being placed in close proximity to inner surfaces of the two lateral walls 20, 22. Further, the window covering fixing piece 48 comprises a fixing projection 73 projecting from the main body 67. The fixing projection 73 is elongated and relatively thin for placement between the window covering 41 and one of the lateral walls 20. The fixing projection 73 has a tapering free end. The fixing projection 73 extends from a lateral portion of the main body 67. The fixing projection 73 is in one piece with the main body 67.

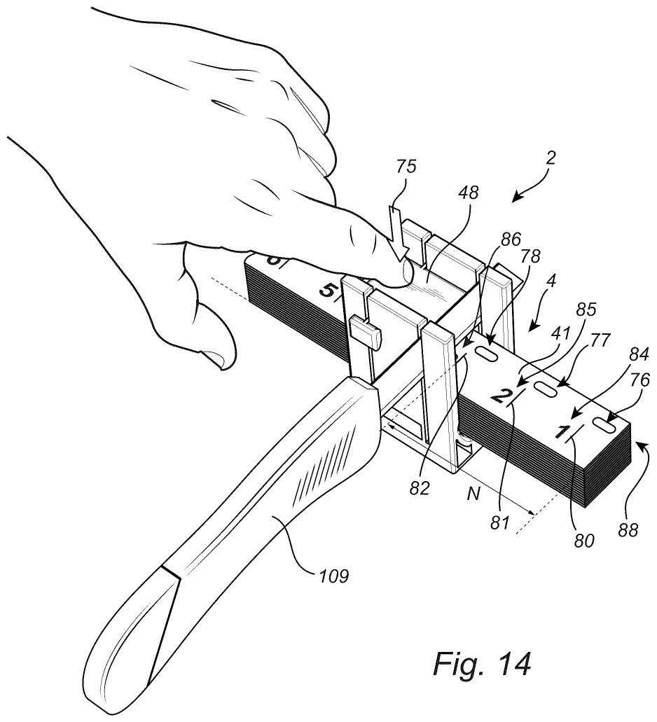

FIG. 14 is a perspective view from above of the resizing device and the window covering according to FIG. 13 in an operative position for cutting. An operator or end user is exerting a pressure on top of the fixing piece 48, see arrow 75, so that the window covering 41 is maintained in a compressed state during cutting. It may be noted that the cutting tool 109 is in the form of a knife.

It may be noted that the window covering cross bar receptacle 34 and the window covering receptacle 44 are defined by the same space for cutting of one of the window covering cross bar 35 and the window covering 41 in a first cutting operation and cutting of a second one of the window covering cross bar 35 and the window covering 41 in a second cutting operation in a consecutive step. According to one example, the window covering 41 is first placed in the receptacle 34, 44, cut in the first cutting operation and then removed from the resizing device 2. In a consecutive step, the window covering cross bar 35 is placed in the receptacle 34, 44 after removal of the window covering 41, cut in the second cutting operation and then removed from the resizing device 2.

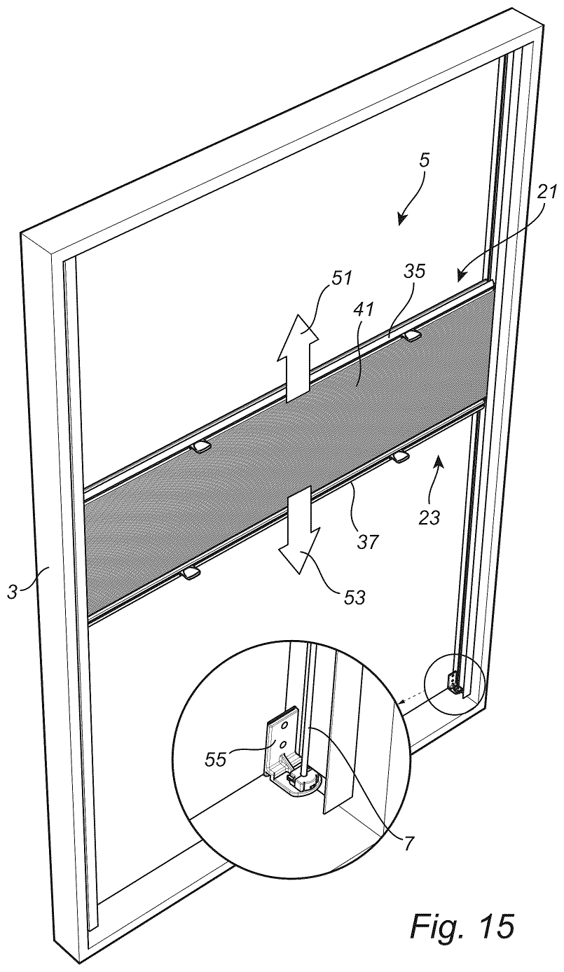

FIG. 15 is a perspective view of the resized window covering arrangement 5 assembled in the window frame 3 according to FIG. 1. It is disclosed that the window covering 41 is freely supported, wherein either end 21, 23 may be moved towards and away from the other end of the window covering 41, see arrows 51, 53.

The window covering arrangement 5 comprises a window covering support rod connector 55 rigidly attached to each end of each one of the rods 7, 17. The connector 55 is adapted to be attached to the wall frame 3 so that the rod 17 may be arranged across the window. The connector 55 is formed by a bracket.

Further, each one of the window covering cross bars 35, 37 comprises a through hole at either end for receipt of the window covering support rod 7, 17. More specifically, each one of the window covering cross bars 35, 37 may comprise an end piece that is removably connectable to a main body of the window covering cross bar 35, 37 (or in one piece with the main body), wherein the end piece in turn comprises the through hole. The through hole of the end piece is adapted for being arranged in-line with the set of apertures for receipt of an end of the window covering support rod 7, 17 in a sliding manner.

More specifically, the end piece is adapted to position the window covering 41 in the different extension states along the window covering support rod 7, 17 via friction. The end piece comprises a spring-biased member arranged inside a housing for contacting an external surface of the window covering support rod 7, 17. The end piece 74 further comprises a spring relief element, which is movably arranged relative to the housing and adapted to move the spring-biased member away from the in-line opening and apertures while compressing the spring. The spring relief element comprises an operator finger contact surface for manually pushing the spring relief element into the housing so that the spring-biased member is moved away from the in-line opening and apertures.

When the window covering support rod 7, 17 has been moved to its operative position in the opening and apertures, the operator may release the pressure on the operator finger contact surface, wherein the spring-biased member will be moved back towards the window covering support rod 7, 17 by means of the spring springing back.

The friction between the spring-biased member and the external surface of the window covering support rod 7, 17 will counteract any relative movements between the window covering 41 and the window covering support rod 7, 17. The spring force of the spring is adapted so that the friction between the spring-biased member and the external surface of the window covering support rod 7, 17 may be overcome by an operator operating the cross bar 35, 37 in a way moving the end of the window covering 41 up or down.

Turning now to FIG. 12 again, the window covering 41 comprises a plurality of sets 76, 77, 78, 79 of in-line apertures, wherein the apertures are arranged in-line with each other in the extension direction of the window covering 41. The plurality of sets 76, 77, 78, 79 of in-line apertures are arranged spaced from each other with equal distances in the transverse direction of the window covering 41. Further, the window covering 41 is provided with a plurality of graduations 80, 81, 82, 83, wherein each graduation is associated to one of the sets 76, 77, 78, 79 of apertures. Further indica 84, 85, 86, 87 is placed adjacent each graduation 80, 81, 82, 83, wherein the indicia represent different intervals of a width of a window frame, in which the window covering is to be placed so that a user gets guidance in selecting one of the graduations 80, 81, 82, 83 for cutting the window covering for properly resizing the window covering.

The sets 76, 77, 78, 79 of apertures are arranged with equal spacing away from an edge 88 of the window covering 41. Further, the graduations 80, 81, 82, 83 are formed by linear parallel lines, wherein one line is associated to each set of apertures. Thus, the graduations 80, 81, 82, 83 are arranged with equal spacing away from the edge 88 of the window covering 41. Further, each indicium 84, 85, 86, 87 comprises a number representative of one of the width intervals of the window frame. Further, the graduations 80, 81, 82, 83 and indicia 84, 85, 86, 87 are applied to an outermost portion of the window covering facing outwards in the extension direction.

Turning now to FIG. 10 again, the window covering cross bar 35 is provided with a plurality of graduations 180, 181, 182, 183, wherein the window covering cross bar graduations 180, 181, 182, 183 are equally spaced in relation to the graduations 80, 81, 82, 83 of the window covering 41. Further indica 184, 185, 186, 187 is placed adjacent each graduation 180, 181, 182, 183, wherein the window covering cross bar indicia 184, 185, 186, 187 are the same as the indicia 84, 85, 86, 87 of the window covering 41.

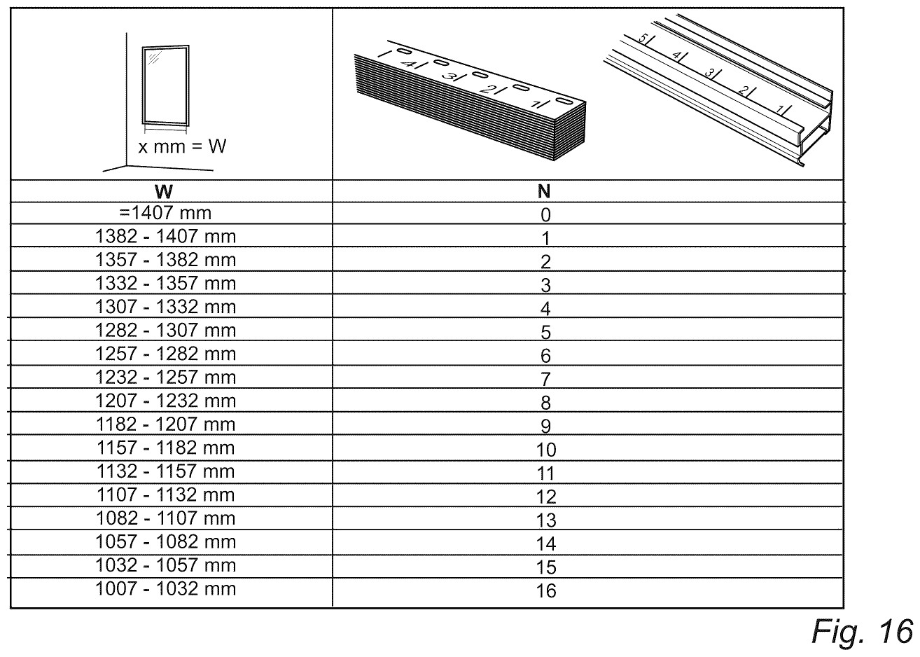

The window covering arrangement 5 further comprises a look-up table, see FIG. 16, that comprises a first column comprising a plurality of width intervals of the window frame and a second column comprising indicia associated to each one of the plurality of width intervals of the window frame. The look-up table may be provided in an instruction for resizing the window covering arrangement.

According to one embodiment, an end user may follow the following process in resizing a window covering 41 and a window covering cross bar 35. In a first step, the user measures an inner width W of the window frame 3, see FIG. 1. In a second step, the user looks in the look-up table, see FIG. 16, and selects an indicium associated to an interval covering the measured inner window frame width from a plurality of indicia associated to different window frame inner width intervals. In a third step, the user identifies a graduation on a first one of the window covering 41 and the cross bar 35 associated to the selected indicium. In a third step, the user cuts the first one of the window covering 41 and the cross bar 35 by means of the cutting tool and the resizing device 2 as described above at the identified graduation. In a fourth step, the user identifies a graduation on a second one of the window covering 41 and the cross bar 35 associated to the selected indicium. In a fifth step, the user cuts the second one of the window covering 41 and the cross bar 35 by means of the cutting tool and the resizing device 2 as described above at the identified graduation.

It is to be understood that the present invention is not limited to the embodiments described above and illustrated in the drawings; rather, the skilled person will recognize that many changes and modifications may be made within the scope of the appended claims.

According to one alternative, the covering comprises a sheet of material free from pleatings, wherein it may be wound up on a roll, wherein the sheet of material may be extended from the roll by a rotation of the roll. A free end of the sheet of material may then be supported by two spaced window covering support rods via a window covering cross bar as described above.

According to a further alternative, the window covering may be discontinuous, wherein it may have a plurality of separate, interconnected and spaced parallel vane members or slats. The vane members may be arranged to be in parallel with each other in all operative states. The vane members may be arranged to assume different inclined positions in the operative states. The vane members may be interconnected via the elongated rigid support elements and assume a packed condition with decreased internal spacing in the retracted state.

Example 1: A device (2) for resizing a window covering arrangement to fit within a window frame adjacent a window, wherein the device comprises a retainer (4) that comprises a rod receptacle (6) for receiving a window covering support rod (7) and a first cutting guide (8) adapted to guide a first cutting tool during cutting of the rod for shortening the rod.

Example 2: A device according to Example 1, wherein the rod receptacle (6) comprises two rod contact surfaces (10, 12) spaced from each other and in an angled relationship forming a tapering shape for supporting the rod during the cutting of the rod.

Example 3: A device according to Example 1 or 2, wherein the rod receptacle (6) defines an elongated recess (14) adapted for receiving the rod in a way that a longitudinal direction of the rod is in parallel with a longitudinal direction of the elongated recess.

Example 4: A device according to any preceding Example, wherein the first cutting guide (8) comprises at least one cutting slot (16, 18).

Example 5: A device according to any preceding Example, wherein the retainer (4) comprises two lateral walls (20, 22) arranged in a spaced relationship, wherein the rod receptacle (6) for receiving the rod is located between the lateral walls (20, 22) and wherein the first cutting guide is formed in at least one of the lateral walls.

Example 6: A device according to Example 5, wherein the first cutting guide comprises a first cutting slot (16) arranged in a first one of the lateral walls (20) and a second cutting slot (18) arranged in a second one of the lateral walls (22) and wherein the first cutting slot (16) and the second cutting slot (18) are aligned for simultaneously receiving one single cutting tool.

Example 7: A device according to any preceding Example, wherein the retainer (4) comprises a bottom wall (24), wherein the rod receptacle (6) is arranged on a first side (26) of the bottom wall (24) and wherein the rod receptacle is open in a first direction perpendicular to a main extension plane of the bottom wall.

Example 8: A device according to Example 3 and 7, wherein the retainer (4) comprises an elongated portion (28) projecting from the bottom wall (24), wherein the rod receptacle (6) is formed in the elongated portion (28) so that the elongated rod receiving recess (14) extends in parallel with the elongated portion (28).

Example 9: A device according to Example 5 and Example 7 or 8, wherein the two lateral walls (20, 22) extend upwards from the bottom wall (24), wherein the rod receptacle (6) is arranged between the two lateral walls.

Example 10: A device according to anyone of Examples 7-9, wherein the bottom wall (24) comprises a support surface (30) arranged on a second side (32) of the bottom wall (24), wherein the support surface faces in a second direction opposite the first direction for supporting the device against an external support during the cutting of the rod.

Example 11: A device according to any preceding Example, wherein the retainer (4) comprises a window covering cross bar receptacle (34) for receiving a window covering cross bar (35, 37) and a second cutting guide (36) adapted to guide a second cutting tool during cutting of the cross bar for shortening the cross bar.

Example 12: A device according to Example 5, 8 and 11, wherein the window covering cross bar receptacle (34) is defined in a sideways direction by the two lateral walls (20, 22) and in a downwards direction by an upper surface (38) of the elongated portion (28).

Example 13: A device according to Example 7 and Example 11 or 12, wherein the window covering cross bar receptacle (34) comprises an elongated recess (40, 42) that is open in the first direction for receiving a complimentary shaped portion (39) of the cross bar for holding the cross bar in a fixed position during cutting and wherein the cross bar elongated recess is spaced from the rod receptacle.

Example 14: A device according to any one of Examples 11-13, wherein the second cutting guide (36) is formed by the same structure as the first cutting guide (8).

Example 15: A device according to any preceding Example, wherein the retainer (4) comprises a window covering receptacle (44) for receiving a window covering (41) in a compressed state and a third cutting guide (46) adapted to guide a third cutting tool during cutting of the window covering for shortening the window covering in a sideways direction.

Example 16: A device according to Example 5, 8 and 15, wherein the window covering receptacle (44) is defined in a sideways direction by the two lateral walls (20, 22) and in a downwards direction by an upper surface (38) of the elongated portion (28).

Example 17: A device according to Example 15 or 16, wherein the third cutting guide (46) is formed by the same structure as the first cutting guide (8).

Example 18: A device according to Example 7 and any one of Examples 15-17, wherein the device comprises a window covering fixing piece (48) that is adapted to fix the window covering (41) in the compressed state during cutting, wherein the retainer (4) and the fixing piece (48) comprises complimentary shaped guide means (50, 52; 54, 56) for guiding the fixing piece in a direction towards the bottom wall (24) for acting on the window covering.

Example 19: A device according to Example 18, wherein the holding piece guide means (50, 52) in the retainer (4) is arranged spaced from the first cutting guide (8).

Example 20: A device according to any one of Examples 11-14 and any one of Examples 15-19, wherein the window covering cross bar receptacle (34) and the window covering receptacle (44) are at least partly defined by the same space for cutting of one of the window covering cross bar and the window covering in a first cutting operation and cutting of a second one of the window covering cross bar and the window covering in a second cutting operation.

Example 21: A window covering arrangement comprising a window covering (41) adapted for being arranged in different intermediate extension states between a retracted state and an extended state for covering a window to different extents, wherein the window covering (41) comprises a plurality of sets (76, 77, 78, 79) of apertures, wherein the apertures in each set are arranged in-line with each other in the extension direction of the window covering for receipt of a rod (7, 17) so that the window covering may be supported by the rod and movably arranged in a longitudinal direction of the rod between the different extension states in the extension direction, wherein the sets (76, 77, 78, 79) of apertures are spaced from each other in a direction perpendicular to the window covering extension direction, wherein the window covering (41) is provided with a plurality of graduations (80, 81, 82, 83), wherein each graduation is associated to one of the sets of apertures, wherein indica (84, 85, 86, 87) is placed adjacent each graduation, wherein the indicia represent different intervals of a width of a window frame, in which the window covering is to be placed so that a user gets guidance in selecting one of the graduations for cutting the window covering for properly resizing the window covering.

Example 22: A window covering arrangement according to Example 21, wherein the sets (76, 77, 78, 79) of apertures are arranged with equal spacing from each other in the direction perpendicular to the window covering extension direction.

Example 23: A window covering arrangement according to Example 21 or 22, wherein the sets (76, 77, 78, 79) of apertures are arranged at different distances away from an edge (88) of the window covering.

Example 24: A window covering arrangement according to any one of Examples 21-23, wherein the graduations (80, 81, 82, 83) are formed by linear parallel lines.

Example 25: A window covering arrangement according to any one of Examples 21-24, wherein each indicium (84, 85, 86, 87) comprises a number and/or letter representative of one of the width intervals of the window frame.

Example 26: A window covering arrangement according to any one of Examples 21-25, wherein the graduations (80, 81, 82, 83) and indicia (84, 85, 86, 87) are applied to an outermost portion of the window covering facing outwards in the extension direction.

Example 27: A window covering arrangement according to any one of Examples 21-26, wherein the window covering arrangement comprises a look-up table that comprises a plurality of width intervals of the window frame and indicia associated to each one of the plurality of width intervals of the window frame.

Example 28: A window covering arrangement according to any one of Examples 21-27, wherein the window covering arrangement comprises at least one window covering cross bar (35, 37) that is adapted to extend in a transverse direction of the window covering (41) and comprises an engagement portion for engagement with one of the opposite ends of the window covering in its extension direction so that the window covering may be moved to different extension states via movement of the window covering cross bar, wherein the window covering cross bar is provided with graduations (180, 181, 182, 183) and indicia (184, 185, 186, 187) corresponding to the graduations and indicia provided on the window covering (41) for properly resizing the window covering cross bar.

1. A device for resizing a window covering arrangement to fit within a window frame adjacent a window, comprising: a retainer that comprises a rod receptacle for receiving a window covering support rod,
wherein the retainer comprises:
a window covering cross bar receptacle for receiving a window covering cross bar and/or
a window covering receptacle for receiving a window covering in a compressed state, and
at least a first cutting guide adapted to guide a first, second, and/or third cutting tool during cutting of the rod for shortening the rod, during cutting of the cross bar for shortening the cross bar, and/or during cutting of the window covering for shortening the window covering in a sideways direction.

2. The device according to claim 1, wherein the rod receptacle comprises two rod contact surfaces spaced from each other and in an angled relationship forming a tapering shape for supporting the rod during the cutting of the rod.

3. The device according to claim 1, wherein the rod receptacle defines an elongated recess adapted for receiving the rod in a way that a longitudinal direction of the rod is in parallel with a longitudinal direction of the elongated recess.

4. The device according to claim 1, wherein the first cutting guide comprises at least one cutting slot.

5. The device according to claim 1, wherein the retainer comprises two lateral walls arranged in a spaced relationship, wherein the rod receptacle for receiving the rod is located between the two lateral walls and wherein the first cutting guide is formed in at least one of the two lateral walls.

6. The device according to claim 5, wherein the first cutting guide comprises a first cutting slot arranged in a first one of the two lateral walls and a second cutting slot arranged in a second one of the two lateral walls, and wherein the first cutting slot and the second cutting slot are aligned for simultaneously receiving one single cutting tool.

7. The device according to claim 1, wherein the retainer comprises a bottom wall, wherein the rod receptacle is arranged on a first side of the bottom wall, and wherein the rod receptacle is open in a first direction perpendicular to a main extension plane of the bottom wall.

8. The device according to claim 7, wherein the rod receptacle defines an elongated recess adapted for receiving the rod in a way that a longitudinal direction of the rod is in parallel with a longitudinal direction of the elongated recess, wherein the retainer comprises an elongated portion projecting from the bottom wall, wherein the rod receptacle is disposed in the elongated portion so that the elongated rod receiving recess extends in parallel with the elongated portion.

9. The device according claim 7, wherein the retainer comprises two lateral walls arranged in a spaced relationship, wherein the rod receptacle for receiving the rod is located between the two lateral walls and wherein the first cutting guide is formed in at least one of the two lateral walls, wherein the two lateral walls extend upwards from the bottom wall, and wherein the rod receptacle is arranged between the two lateral walls.

10. The device according to claim 7, wherein the bottom wall comprises a support surface arranged on a second side of the bottom wall, wherein the support surface faces in a second direction opposite the first direction for supporting the device against an external support during the cutting of the rod.

11. The device according to claim 1, wherein the retainer comprises a window covering cross bar receptacle for receiving a window covering cross bar and a second cutting guide adapted to guide a second cutting tool during cutting of the cross bar for shortening the cross bar.

12. The device according to claim 11,
wherein the retainer comprises two lateral walls arranged in a spaced relationship, wherein the rod receptacle for receiving the rod is located between the two lateral walls and wherein the first cutting guide is formed in at least one of the two lateral walls,
wherein the retainer comprises a bottom wall, wherein the rod receptacle is arranged on a first side of the bottom wall, and wherein the rod receptacle is open in a first direction perpendicular to a main extension plane of the bottom wall,
wherein the rod receptacle defines an elongated recess adapted for receiving the rod in a way that a longitudinal direction of the rod is in parallel with a longitudinal direction of the elongated recess, wherein the retainer comprises an elongated portion projecting from the bottom wall, wherein the rod receptacle is disposed in the elongated portion so that the elongated rod receiving recess extends in parallel with the elongated portion, and
wherein the window covering cross bar receptacle is defined in a sideways direction by the two lateral walls and in a downwards direction by an upper surface of the elongated portion.

13. The device according to claim 11, wherein the retainer comprises a bottom wall, wherein the rod receptacle is arranged on a first side of the bottom wall, and wherein the rod receptacle is open in a first direction perpendicular to a main extension plane of the bottom wall, wherein the window covering cross bar receptacle comprises an elongated recess that is open in the first direction for receiving a complimentary shaped portion of the cross bar for holding the cross bar in a fixed position during cutting, and wherein the cross bar elongated recess is spaced from the rod receptacle.

14. The device according to claim 1, wherein the retainer comprises a window covering cross bar receptacle for receiving a window covering cross bar and wherein the first cutting guide is further adapted to guide a second cutting tool during cutting of the cross bar for shortening the cross bar.

15. The device according to claim 1, wherein the retainer comprises a window covering receptacle for receiving a window covering in a compressed state and a third cutting guide adapted to guide a third cutting tool during cutting of the window covering for shortening the window covering in a sideways direction.

16. The device according to claim 15,
wherein the retainer comprises two lateral walls arranged in a spaced relationship, wherein the rod receptacle for receiving the rod is located between the two lateral walls and wherein the first cutting guide is formed in at least one of the two lateral walls,
wherein the retainer comprises a bottom wall, wherein the rod receptacle is arranged on a first side of the bottom wall, and wherein the rod receptacle is open in a first direction perpendicular to a main extension plane of the bottom wall,
wherein the rod receptacle defines an elongated recess adapted for receiving the rod in a way that a longitudinal direction of the rod is in parallel with a longitudinal direction of the elongated recess, wherein the retainer comprises an elongated portion projecting from the bottom wall, wherein the rod receptacle is disposed in the elongated portion so that the elongated rod receiving recess extends in parallel with the elongated portion,
wherein the window covering receptacle is defined in a sideways direction by the two lateral walls and in a downwards direction by an upper surface of the elongated portion.

17. The device according to claim 1, wherein the retainer comprises a window covering receptacle for receiving a window covering in a compressed state, and wherein the first cutting guide is further adapted to guide a third cutting tool during cutting of the window covering for shortening the window covering in a sideways direction.

18. The device according to claim 15,
wherein the retainer comprises a bottom wall, wherein the rod receptacle is arranged on a first side of the bottom wall, and wherein the rod receptacle is open in a first direction perpendicular to a main extension plane of the bottom wall, and
further comprising a window covering fixing piece that is adapted to fix the window covering in the compressed state during cutting, wherein the retainer and the fixing piece comprises complimentary shaped guides for guiding the fixing piece in a direction towards the bottom wall for acting on the window covering.

19. The device according to claim 18, wherein the guides in the retainer is arranged spaced from the first cutting guide.

20. The device according to claim 15,
wherein the retainer comprises a window covering cross bar receptacle for receiving a window covering cross bar and a second cutting guide adapted to guide a second cutting tool during cutting of the cross bar for shortening the cross bar, and
wherein the window covering cross bar receptacle and the window covering receptacle are at least partly defined by the same space for cutting of one of the window covering cross bar and the window covering in a first cutting operation and cutting of a second one of the window covering cross bar and the window covering in a second cutting operation.

21. A window covering arrangement, comprising:
a window covering adapted for being arranged in different intermediate extension states between a retracted state and an extended state for covering a window to different extents,
wherein the window covering comprises a plurality of sets of apertures, wherein the apertures in each set are arranged in-line with each other in the extension direction of the window covering for receipt of a rod so that the window covering is supportable by the rod and movably arranged in a longitudinal direction of the rod between the different extension states in the extension direction, wherein the sets of apertures are spaced from each other in a direction perpendicular to the window covering extension direction,
wherein the window covering is provided with a plurality of graduations wherein each graduation is associated to one of the sets of apertures,
wherein indica is placed adjacent each graduation, wherein the indicia represent different intervals of a width of a window frame, in which the window covering is to be placed so that a user gets guidance in selecting one of the graduations for cutting the window covering for properly resizing the window covering.

22. The window covering arrangement according to claim 21, wherein the sets of apertures are arranged with equal spacing from each other in the direction perpendicular to the window covering extension direction.

23. The window covering arrangement according to claim 21, wherein the sets of apertures are arranged at different distances away from an edge of the window covering.

24. The window covering arrangement according to claim 21, wherein the graduations are formed by linear parallel lines.

25. The window covering arrangement according to claim 21, wherein each indicium comprises a number and/or letter representative of one of the width intervals of the window frame.

26. The window covering arrangement according to claim 21, wherein the graduations and indicia are applied to an outermost portion of the window covering facing outwards in the extension direction.

27. The window covering arrangement according to claim 21, wherein the window covering arrangement comprises a look-up table that comprises a plurality of width intervals of the window frame and indicia associated to each one of the plurality of width intervals of the window frame.

28. The window covering arrangement according to claim 21, further comprising at least one window covering cross bar that is adapted to extend in a transverse direction of the window covering and comprises an engagement portion for engagement with one of the opposite ends of the window covering in its extension direction so that the window covering may be moved to different extension states via movement of the window covering cross bar, wherein the window covering cross bar is provided with graduations and indicia corresponding to the graduations and the indicia provided on the window covering for properly resizing the window covering cross bar.
